(19) United States
(12) Patent Application Publication
(10) Pub. No.: US 2026/0299927 A1
(43) Pub. Date: Oct. 1, 2026

(54) SOFTWARE UPDATE SYSTEM, VEHICLE, SOFTWARE UPDATE DEVICE, AND SOFTWARE UPDATE METHOD

(71) Applicant: HONDA MOTOR CO., LTD., Tokyo (JP)

(72) Inventor: Yasumasa Kaitani, Tokyo (JP)

(21) Appl. No.: 19/566,354

(22) Filed: Mar. 13, 2026

(30) Foreign Application Priority Data
Mar. 27, 2025 (JP) 2025-054075

(51) Int. Cl. G06F 8/65; B60L 50/60; B60R 16/023; B60R 16/033

(52) U.S. Cl. CPC G06F 8/65; B60R 16/0231; B60R 16/033; B60L 50/60

(57) ABSTRACT

A software update system includes: a vehicle including a high-voltage battery that supplies electric power to high-voltage system equipment; a low-voltage battery that supplies electric power to low-voltage system equipment; a processor that performs update of software of electronic control units, that controls the high-voltage system equipment, and that controls the low-voltage system equipment, wherein the processor transmits first information inquiring presence or absence of information related to the update of the software to a server device, receives update software from the server device, and determines, based on at least one of the electronic control units to be a target of the update software, whether or not to make a transition to an activation process according to at least one of remaining electric power of the high-voltage battery and remaining electric power of the low-voltage battery.

### INCORPORATION BY REFERENCE

The present application claims priority under 35 U.S.C. § 119 to Japanese Patent Application No. 2025-054075 filed on Mar. 27, 2025. The content of the application is incorporated herein by reference in its entirety.

### BACKGROUND OF THE INVENTION

### FIELD OF THE INVENTION

The present invention relates to a software update system, a vehicle, a software update device, and a software update method.

### Description of the Related Art

A technique for updating software in a vehicle including a high-voltage battery and a low-voltage battery has conventionally been known. For example, Japanese Patent Laid-open No. 2022-054890 discloses a technique for updating a program by using a low-voltage battery when reprogramming can be performed by using a low-voltage battery and updating the program by using a high-voltage battery when reprogramming cannot be performed by using a low-voltage battery.

In update of software in vehicles, it is common practice to perform an activation process of update software. For the activation process, a battery applicable to the activation process is required. For example, in a case where software to be updated is software of equipment related to a low-voltage battery, it is required to stop the output of the low-voltage battery and to perform the activation process with the high-voltage battery. Alternatively, for example, in a case where software to be updated is software of equipment related to a high-voltage battery, it is required to stop the output of the high-voltage battery and to perform the activation process with the low-voltage battery. However, as in Japanese Patent Laid-open No. 2022-054890, in a configuration where transition determination to an activation process is made based on the remaining electric power of the batteries, the types of the batteries are not taken into consideration in the transition determination to the activation process. Therefore, some software to be updated may be unable to appropriately make the transition determination to the activation process.

An object of the present invention, which has been made in view of the above circumstances, is to make it possible to appropriately make the transition determination to the activation process.

### SUMMARY OF THE INVENTION

An aspect of the present invention is a software update system including: a vehicle including electronic control units; and a server device capable of communicating with the vehicle, wherein the vehicle includes a software update unit that performs update of software of the electronic control units, high-voltage system equipment, a high-voltage battery that supplies electric power to the high-voltage system equipment, a high-voltage system electronic control unit that is one of the electronic control units, the high-voltage system electronic control unit controlling the high-voltage system equipment, low-voltage system equipment, a low-voltage battery that supplies electric power to the low-voltage system equipment, and a low-voltage system electronic control unit that is another one of the electronic control units, the low-voltage system electronic control unit controlling the low-voltage system equipment, and wherein the software update unit transmits first information inquiring presence or absence of information related to the update of the software to the server device, receives second information including update software from the server device, and determines, based on at least one of the electronic control units to be a target of the update software included in the second information, whether or not to make a transition to an activation process of the update software according to at least one of remaining electric power of the high-voltage battery and remaining electric power of the low-voltage battery.

According to one aspect of the present invention, the transition determination to the activation process can be made appropriately.

### BRIEF DESCRIPTION OF THE DRAWINGS

FIG. 1 is a diagram showing the structure of a software update system;

FIG. 2 is a diagram showing the configuration of a server device;

FIG. 3 is a diagram showing the configuration of a vehicle;

FIG. 4 is a sequence diagram showing the operation of the software update device and the server device; and

FIG. 5 is a flowchart showing the operation of a software update unit.

### DETAILED DESCRIPTION OF THE INVENTION

### 1. Configuration of Software Update System

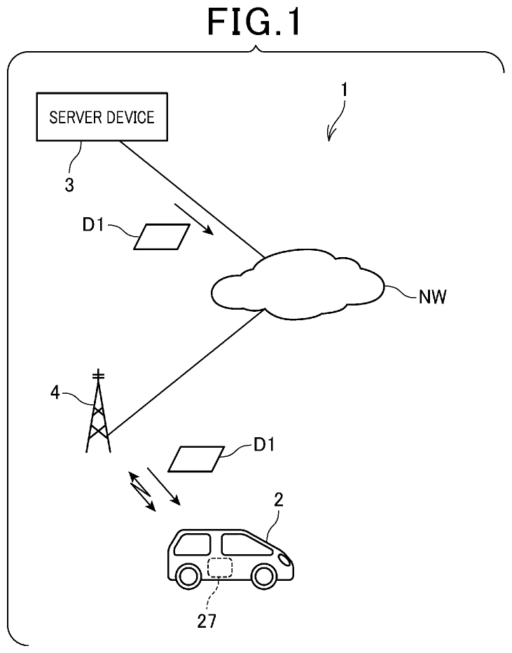

FIG. 1 is a diagram showing the configuration of a software update system 1.

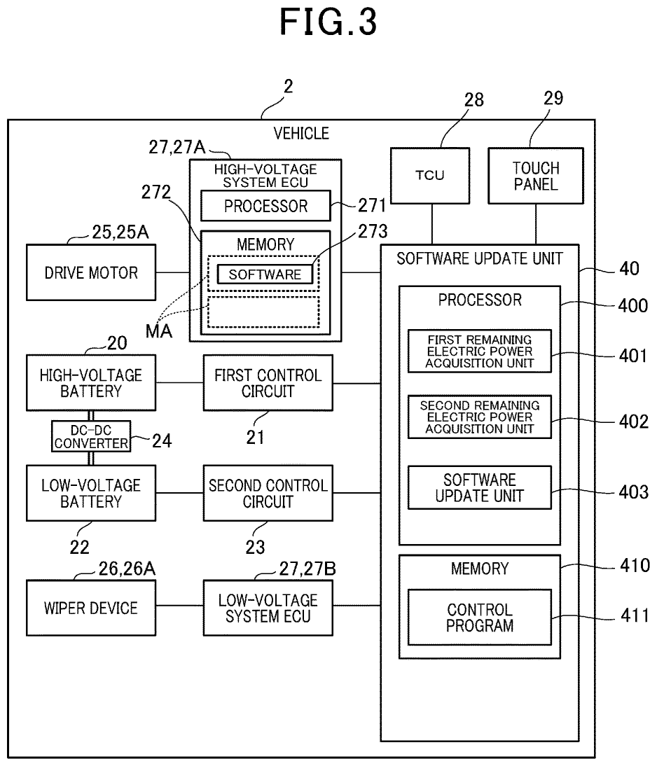

The software update system 1 includes a vehicle 2 and a server device 3 that provides software 273 (see FIG. 3) to be executed by an electronic control unit (ECU) 27 owned by the vehicle 2. The vehicle 2 and the server device 3 are communicatively connected to the vehicle 2 through a communication network NW. The vehicle 2 downloads software for update (hereinafter, with a reference sign “D1” attached thereto, expressed as update software D1) from the server device 3 and updates the software 273 provided in the ECU 27. That is, the software update system 1 enables over-the-air (OTA) update of the software 273 of the vehicle 2.

The ECU 27 is an example of “electronic control units”.

In the following description, the term software includes programs to be executed by a processor and data that is referenced, generated, updated, deleted, and the like in relation to the programs. The expression updating software refers to a process of replacing software to be executed by the processor with software of a newer version, which may be achieved in any specific way that includes addition, deletion, and overwriting of the software. Updating the software may also include processes of deleting some or all of the software to be executed by the processor, installing new software, and deleting, adding, and overwriting data used in the execution of software.

The vehicle 2 may be any of a four-wheeled vehicle, a two-wheeled vehicle, and other vehicles, or may be a heavy-duty vehicle, a commercial vehicle, a working vehicle, or the like. As an example, this embodiment describes a four-wheeled vehicle. The vehicle 2 is connected to the communication network NW by wireless communication via, for example, a base station 4 of cellular communication. The specific form of the communication network NW is not limited. For example, the communication network NW may include a cellular communication network, the Internet, a wide area network (WAN), a local area network (LAN), a public network, a provider device, a dedicated line, a base station, and the like.

The server device 3 is a computer connected to the communication network NW via a wired communication line or a wireless communication line and communicatively connected to the vehicle 2. The server device 3 transmits the update software D1 to the vehicle 2.

### 2. Configuration of Server Device

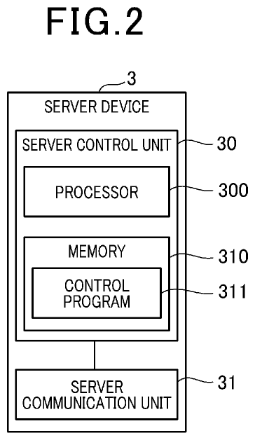

First, with reference to FIG. 2, the configuration of the server device 3 will be described.

FIG. 2 is a diagram showing the configuration of the server device 3.

The server device 3 includes a server control unit 30 and a server communication unit 31.

The server control unit 30 includes a processor 300, such as a central processing unit (CPU), a memory 310, and an interface circuit for connecting other devices and sensors. The server control unit 30 connects with the server communication unit 31. The server control unit 30 reads and executes a control program 311 stored in the memory 310 to perform various operations.

The memory 310 is a storage device storing programs and data. The memory 310 stores the control program 311, data to be processed by the processor 300, and the like. The memory 310 has a nonvolatile storage area. The memory 310 also has a volatile storage area and constitutes a working area for the processor 300. For example, the memory 310 is implemented by a read only memory (ROM) or a random access memory (RAM).

The server communication unit 31 includes hardware such as a communication circuit and communicates with the vehicle 2 as controlled by the server control unit 30.

### 3. Configuration of Vehicle

FIG. 3 is a diagram showing the configuration of the vehicle 2.

The vehicle 2 includes a high-voltage battery 20, a first control circuit 21, a low-voltage battery 22, a second control circuit 23, a DC-DC converter 24, high-voltage system equipment 25, low-voltage system equipment 26, a plurality of ECUs 27, a telematics control unit (TCU) 28, a touch panel 29, and a software update device 40.

The high-voltage battery 20 is a battery that supplies electric power to the high-voltage system equipment 25. The high-voltage battery 20 also supplies electric power to a low-voltage system ECU 27B to be described later in a case where the low-voltage system ECU 27B performs the activation process. The high-voltage battery 20 is controlled in electric power supply and charging by the first control circuit 21. The first control circuit 21 connects to the software update device 40 and controls the electric power supply of the high-voltage battery 20 as controlled by the software update device 40.

The low-voltage battery 22 is a battery that supplies electric power to the low-voltage system equipment 26. The low-voltage battery 22 also supplies electric power to a high-voltage system ECU 27A to be described later in a case where the high-voltage system ECU 27A performs the activation process. The low-voltage battery 22 is controlled in electric power supply and charging by the second control circuit 23. The second control circuit 23 connects to the software update device 40 and controls the electric power supply of the low-voltage battery 22 as controlled by the software update device 40.

The high-voltage battery 20 and the low-voltage battery 22 are connected to each other via the DC-DC converter 24. This enables the DC-DC converter 24 to lower the electric power of the high-voltage battery 20 to output the lowered electric power to the low-voltage battery 22.

The high-voltage system equipment 25 is equipment that operates based on the electric power from the high-voltage battery 20. In this embodiment, a drive motor 25A is exemplified as the high-voltage system equipment 25. The drive motor 25A is a motor operated by electric power and serves as the driving source of the vehicle 2.

The low-voltage system equipment 26 is equipment that operates based on electric power from the low-voltage battery 22. In this embodiment, a wiper device 26A is exemplified as the low-voltage system equipment 26.

The wiper device 26A is a device that operates wipers of the vehicle 2.

The high-voltage battery 20 has a higher voltage than the low-voltage battery 22, and the high-voltage battery 20 supplies power to the drive motor 25A, while the low-voltage battery 22 supplies power to the wiper device 26A.

The ECUs 27 are electronic control devices that control equipment provided in the vehicle 2 and connect to the software update device 40. Each ECU 27 includes a processor 271, such as a CPU, and a memory 272, and controls the connected equipment by the processor 271 reading and executing the software 273 stored in the memory 272.

The memory 272 is a storage device that stores programs and data. The memory 272 stores the software 273 and data to be processed by the processor 271. The memory 272 is a double bank memory (so-called 2-sided ROM). The memory 272 has a volatile storage area and may constitute a working area for the processor 271.

The vehicle 2 of this embodiment includes, as the ECUs 27, the high-voltage system ECU 27A and the low-voltage system ECU 27B.

The high-voltage system ECU 27A connects with the drive motor 25A and controls the drive motor 25A.

The low-voltage system ECU 27B connects with the wiper device 26A and controls the wiper device 26A.

The high-voltage system ECU 27A is an example of “high-voltage system electronic control units”. The low-voltage system ECU 27B is an example of “low-voltage system electronic control units”.

The TCU 28 is a communication device that conforms to the communication standard of the vehicle 2 and communicates with devices other than the vehicle 2. The TCU 28 includes, for example, an antenna, a transmitter, a receiver, and the like, and communicates with the server device 3 as controlled by the software update device 40.

The touch panel 29, which is composed of a display and a touch sensor, accepts a touch operation and displays various types of information.

The software update device 40 is a device that updates the software 273 of the ECUs 27. The software update device 40 includes a processor 400, such as a CPU, a memory 410, and an interface circuit for connecting other devices and sensors.

The memory 410 is a storage device that stores programs and data. The memory 410 stores a control program 411 and data to be processed by the processor 400. The memory 410 has a nonvolatile storage area. The memory 410 also has a volatile storage area and constitutes a working area for the processor 400. For example, the memory 410 is composed of a ROM and a RAM.

The processor 400 executes the control program 411 to thereby function as a first remaining electric power acquisition unit 401, a second remaining electric power acquisition unit 402, and a software update unit 403.

The first remaining electric power acquisition unit 401 acquires the remaining electric power of the high-voltage battery 20. The first remaining electric power acquisition unit 401 may acquire the remaining electric power of the high-voltage battery 20 from the first control circuit 21, or may directly detect the voltage or current of the high-voltage battery 20 to acquire the remaining electric power of the high-voltage battery 20.

The second remaining electric power acquisition unit 402 acquires the remaining electric power of the low-voltage battery 22. The second remaining electric power acquisition unit 402 may acquire the remaining electric power of the low-voltage battery 22 from the second control circuit 23, or may directly detect the voltage or current of the low-voltage battery 22 to acquire the remaining electric power of the low-voltage battery 22.

The software update unit 403 updates the software 273 owned by the ECU 27. The software update unit 403 performs a process of inquiring presence or absence of information related to update of the software 273, a process of downloading the update software D1, a process of installing the update software D1 onto the target ECU 27, and a process of causing the ECU 27 to perform the activation process of the update software D1.

### 4. Operation

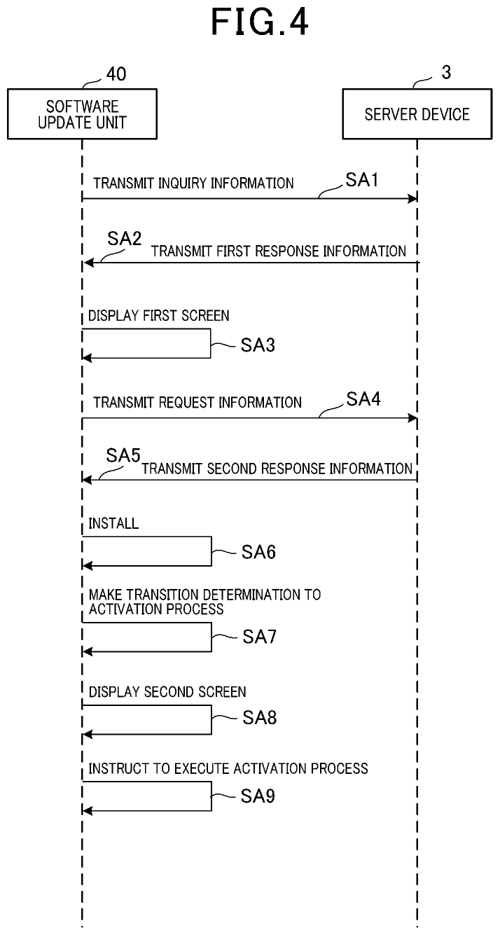

Next, with reference to FIG. 4, the operation related to the update of the software 273 of each unit of the software update system 1 will be described.

FIG. 4 is a sequence diagram showing the operation of the software update device 40 and the server device 3.

The software update unit 403 transmits inquiry information via the TCU 28 to the server device 3 (step SA1), the inquiry information inquiring presence or absence of information related to the update of the software 273.

The inquiry information is an example of “first information”.

Upon receiving the inquiry information via the server communication unit 31, the server control unit 30 transmits first response information to the vehicle 2 (step SA2).

The first response information is information indicating a response to the information transmission from the vehicle 2 and information indicating presence or absence of information related to the update of the software 273.

The software update unit 403 receives the first response information via the TCU 28, and displays, in a case where the received first response information indicates presence of the update of the software 273, on the touch panel 29 a first screen that inquires the user of the vehicle 2 whether or not to perform update of the software 273 (step SA3). This inquiry to the user is made as required. For example, in the case of software update for the purpose of defect measures, the update may be performed without inquiring the user.

Upon instructed to perform update of the software 273 on the first screen, the software update unit 403 transmits, via the TCU 28, request information requesting the update software D1 to the server device 3 (step SA4).

Upon receiving the request information via the server communication unit 31, the server control unit 30 transmits second response information to the vehicle 2 (step SA5).

The second response information is information indicating a response to the information transmission from the vehicle 2 and includes the update software D1.

The second response information is an example of “second information”.

Upon receiving the second information from the server device 3, in other words, upon downloading the update software D1 from the server device 3, the software update unit 403 installs the downloaded update software D1 onto the ECU 27 to be updated (step SA6).

To describe step SA6 in detail, the software update unit 403 transfers the update software D1 to the target ECU 27 and instructs the target ECU 27 to write the update software D1 to the memory 272.

As described above, the memory 272 provided in the ECUs 27 is a double bank memory. This enables the ECUs 27 to operate according to the software 273 stored in one storage area MA of the memory 272 while writing the update software D1 to the other storage area MA of the memory 272. Accordingly, the ECUs 27 can write the update software D1 to the memory 272 even when, for example, the vehicle 2 is traveling.

Next, the software update unit 403 determines whether or not to make a transition to the activation process of the update software D1 at the timing when an ignition power source of the vehicle 2 is turned off (step SA7). This transition determination will be described in detail in a flowchart described below.

In a case where the software update unit 403 has determined to make a transition to the activation process, the software update unit 403 displays on the touch panel 29 a second screen that inquires whether or not to start the update of the software (step SA8).

Upon instructed to start the update of the software 273 on the second screen, the software update unit 403 instructs the ECU 27 whose software 273 is to be updated to execute the activation process (step SA9). In the activation process, a time limit within which the activation process can be performed is set. During this time limit, the vehicle 2 cannot be used.

Here, the activation process in the ECU 27 will be described.

Upon receiving the instruction to execute the activation process, the ECU 27 performs the activation process of the update software D1. The activation process of the update software D1 includes a process of setting, at the start-up of the ECU 27, start-up parameters of the ECU 27 so that the written update software D1 is loaded and control according to the update software D1 is started. For example, the activation process of the update software D1 includes a process of enabling, as a readout area, the storage area MA in which the update software D1 is written and disabling, as a readout area, the storage area MA in which the update software D1 is not written.

In the sequence shown in FIG. 4, in a case where the software update unit 403 receives the first response information from the server device 4, the software update unit 403 may skip the process of step SA3 and perform the process of step SA4. In the software update system 1, the processes of steps SA2, SA3, and SA4 may also be skipped. In other words, the software update unit 403 may be configured to receive the second response information on the basis of transmission of the inquiry information as a trigger.

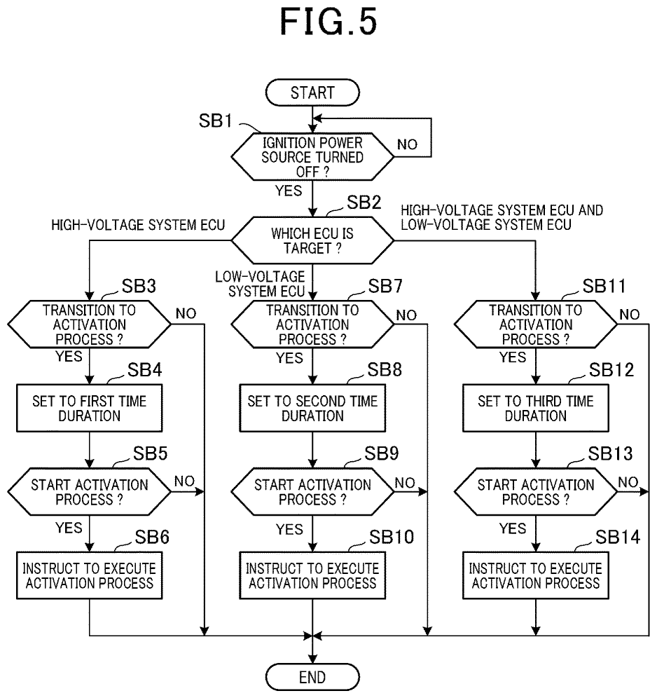

Next, with reference to FIG. 5, the operation related to the transition to the activation process of the software update unit 403 will be described.

FIG. 5 is a flowchart showing the operation of the software update unit 403.

The software update unit 403 determines whether or not the ignition power source has been turned off (step SB1). In a case where the software update unit 403 has determined that the ignition power source has not been turned off (step SB1: NO), the software update unit 403 performs the process of step SB1 again.

On the other hand, in a case where the software update unit 403 has determined that the ignition power source has been turned off (step SB1: YES), the software update unit 403 determines whether the ECU 27 to be the target of the received update software D1 is the high-voltage system ECU 27A, the low-voltage system ECU 27B, or the high-voltage system ECU 27A and the low-voltage system ECU 27B (step SB2).

In step SB2, the software update unit 403 analyzes the update software D1 and makes the determination of step SB2. In a case where the second response information includes information on the ECU 27 to be the target of the update software D1, the software update unit 403 may make the determination of step SB2 on the basis of this information indicating the target.

In a case where the software update unit 403 has determined that the target of the update software D1 is the high-voltage system ECU 27A (step SB2: high-voltage system ECU), the software update unit 403 determines whether or not to make a transition to the activation process on the basis of the remaining electric power of the low-voltage battery 22 (step SB3).

Step SB3 will be described in detail.

In a case where the remaining electric power of the low-voltage battery 22 acquired by the second remaining electric power acquisition unit 402 is equal to or larger than predetermined remaining electric power, the software update unit 403 determines to make a transition to the activation process. On the other hand, in a case where the remaining electric power of the low-voltage battery 22 acquired by the second remaining electric power acquisition unit 402 is lower than the predetermined remaining electric power, the software update unit 403 determines not to make a transition to the activation process. This predetermined remaining electric power is appropriately predefined by a test, simulation, or the like in advance so as to prevent the remaining electric power of the low-voltage battery 22 from running out in the middle of the activation process.

In a case where the software update unit 403 has determined not to make a transition to the activation process (step SB3: NO), the software update unit 403 terminates this process.

On the other hand, in a case where the software update unit 403 has determined to make a transition to the activation process (step SB3: YES), the software update unit 403 sets the time limit within which the activation process can be performed to a first time duration (step SB4). Examples of the first time duration include 600 seconds.

Next, the software update unit 403 determines whether or not to start the activation process (step SB5).

Step SB5 will be described in detail.

In a case where an operation to start the activation process has been input on the second screen, the software update unit 403 makes affirmative determination in step SB5. On the other hand, in a case where an operation not to start the activation process has been input on the second screen or in a case where an operation to start the activation process has not been input on the second screen for a predetermined period or more, the software update unit 403 makes negative determination in step SB5.

In a case where the software update unit 403 has determined not to start the activation process (step SB5: NO), the software update unit 403 terminates this process.

On the other hand, in a case where the software update unit 403 has determined to start the activation process (step SB5: YES), the software update unit 403 instructs the high-voltage system ECU 27A to execute the activation process (step SB6). In a case where the software update unit 403 instructs the high-voltage system ECU 27A to execute the activation process, the software update unit 403 instructs the first control circuit 21 to stop the high-voltage battery 20 and instructs the second control circuit 23 that the low-voltage battery 22 supply electric power to the high-voltage system ECU 27A.

Returning to the description of step SB2, in a case where the software update unit 403 has determined that the target of the update software D1 is the low-voltage system ECU 27B (step SB2: low-voltage system ECU), the software update unit 403 determines whether or not to make a transition to the activation process on the basis of the remaining electric power of the high-voltage battery 20 (step SB7).

Step SB7 will be described in detail.

The software update unit 403 determines to make a transition to the activation process in a case where the remaining electric power of the high-voltage battery 20 acquired by the first remaining electric power acquisition unit 401 is equal to or larger than the predetermined remaining electric power, and determines not to make a transition to the activation process in a case where the remaining electric power of the high-voltage battery 20 acquired by the first remaining electric power acquisition unit 401 is lower than the predetermined remaining electric power. This predetermined remaining electric power is appropriately predefined by a test, simulation, or the like in advance so as to prevent the remaining electric power of the high-voltage battery 20 from running out in the middle of the activation process.

In a case where the software update unit 403 has determined not to make a transition to the activation process (step SB7: NO), the software update unit 403 terminates this process.

On the other hand, in a case where the software update unit 403 has determined to make a transition to the activation process (step SB7: YES), the software update unit 403 sets the time limit for the activation process to a second time duration (step SB8). The second time duration is a time duration longer than the first time duration.

Next, the software update unit 403 determines whether or not to start the activation process (step SB9). The determination of step SB9 is made similarly to step SB5.

In a case where the software update unit 403 has determined not to start the activation process (step SB9: NO), the software update unit 403 terminates this process.

On the other hand, in a case where the software update unit 403 has determined to start the activation process (step SB9: YES), the software update unit 403 instructs the low-voltage system ECU 27B to execute the activation process (step SB10). In a case where the software update unit 403 instructs the low-voltage system ECU 27B to execute the activation process, the software update unit 403 instructs the second control circuit 23 to stop the low-voltage battery 22 and instructs the first control circuit 21 that the high-voltage battery 20 supply electric power to the low-voltage system ECU 27B.

Describing step SB2 again, in a case where the software update unit 403 has determined that the target of the update software D1 is the high-voltage system ECU 27A and the low-voltage system ECU 27B (step SB2: high-voltage system ECU and low-voltage system ECU), the software update unit 403 determines whether or not to make a transition to the activation process on the basis of the remaining electric power of the high-voltage battery 20 and the remaining electric power of the low-voltage battery 22 (step SB11).

Step SB11 will be described in detail.

The software update unit 403 determines not to make a transition to the activation process in a case where the remaining electric power of the high-voltage battery 20 acquired by the first remaining electric power acquisition unit 401 is lower than the predetermined remaining electric power.

On the other hand, in a case where the remaining electric power of the high-voltage battery 20 acquired by the first remaining electric power acquisition unit 401 is equal to or larger than the predetermined remaining electric power, the software update unit 403 determines whether or not a sum total of the remaining electric power of the high-voltage battery 20 acquired by the first remaining electric power acquisition unit 401 and the remaining electric power of the low-voltage battery 22 acquired by the second remaining electric power acquisition unit 402 is equal to or larger than the predetermined remaining electric power. In a case where the software update unit 403 has determined that the sum total is equal to or larger than the predetermined remaining electric power, the software update unit 403 determines to make a transition to the activation process. On the other hand, in a case where the software update unit 403 has determined that the sum total is lower than the predetermined remaining electric power, the software update unit 403 determines not to make a transition to the activation process.

In a case where the software update unit 403 has determined not to make a transition to the activation process (step SB11: NO), the software update unit 403 terminates this process.

On the other hand, in a case where the software update unit 403 has determined to make a transition to the activation process (step SB11: YES), the software update unit 403 sets the time limit for the activation process to a third time duration (step SB12). The third time duration is the sum of the first time duration and the second time duration.

Next, the software update unit 403 determines whether or not to start the activation process (step SB13). The determination of step SB13 is made similarly to the determination of step SB5.

In a case where the software update unit 403 has determined not to start the activation process (step SB13: NO), the software update unit 403 terminates this process.

On the other hand, in a case where the software update unit 403 has determined to start the activation process (step SB13: YES), the software update unit 403 instructs the ECU 27 whose software 273 is to be updated to execute the activation process (step SB14).

Next, step SB14 will be described.

First, the software update unit 403 instructs the high-voltage system ECU 27A to execute the activation process. When the activation process of the high-voltage system ECU 27A is completed, the software update unit 403 then instructs the low-voltage system ECU 27B to execute the activation process.

### 5. Other Embodiments

The above-described embodiment merely shows an aspect thereof, and can be modified and applied as required.

In the above-described embodiment, the drive motor 25A is exemplified as the high-voltage system equipment 25. However, the type of the high-voltage system equipment 25 is not limited to the drive motor 25A, and may be equipment other than the drive motor 25A. In other embodiments, the number of the high-voltage system equipment 25 provided in the vehicle 2 may be plural. In such case, the vehicle 2 is provided with “high-voltage system electronic control units” of the number corresponding to the number of the high-voltage system equipment 25.

In the above-described embodiment, the wiper device 26B is exemplified as the low-voltage system equipment 26. However, the type of the low-voltage system equipment 26 is not limited to the wiper device 26B, and may be equipment other than this device. In other embodiments, the number of the low-voltage system equipment 26 provided in the vehicle 2 may be plural. In such case, the vehicle 2 is provided with “low-voltage system electronic control units” of the number corresponding to the number of the low-voltage system equipment 26.

The processors 271, 300, and 400 may be composed of a plurality of processors or may be composed of a single processor. These processors may be hardware programmed to achieve the functional units described above. In such case, these processors are implemented by, for example, an application specific integrated circuit (ASIC) or a field programmable gate array (FPGA).

The internal configuration of the vehicle 2 shown in FIG. 3 is an example, and the specific implementation is not particularly limited. In other words, hardware individually corresponding to each unit is not necessarily implemented, and it is of course possible to adopt a configuration in which a single processor executes a program to thereby achieve the functions of respective units. Furthermore, a part of the functions achieved by software in the above-described embodiment may be provided as hardware, or a part of the functions achieved by the hardware may be achieved by the software.

The operational step units shown in FIG. 5 are obtained by dividing a process according to its main contents. The present invention is not limited by how to divide the process into units or how to name the divided units. The process may be further divided into more step units according to its contents. The process may also be divided so that one step unit includes more processes. The order of the steps may be changed as appropriate within a range that does not depart from the spirit of the present invention.

In a case where the system update method by the software update device 40 described above is implemented by using the processor 400, the program to be executed by the processor 400 can also be implemented in the form of a recording medium or a transmission medium that transmits the program. That is, the control program 411 can also be implemented by a portable information recording medium with the control program 411 recorded thereon. Examples of the information recording medium include magnetic recording media such as a hard disk, optical recording media such as a CD, and semiconductor storage devices such as a universal serial bus (USB) memory and a solid state drive (SSD), but other recording media can also be used.

### 6. Configurations Supported by the Above Embodiments

The above embodiments support the following configurations.

### Configuration 1

A software update system including: a vehicle including electronic control units; and a server device capable of communicating with the vehicle, wherein the vehicle includes a software update unit that performs update of software of the electronic control units, high-voltage system equipment, a high-voltage battery that supplies electric power to the high-voltage system equipment, a high-voltage system electronic control unit that is one of the electronic control units, the high-voltage system electronic control unit controlling the high-voltage system equipment, low-voltage system equipment, a low-voltage battery that supplies electric power to the low-voltage system equipment, and a low-voltage system electronic control unit that is another one of the electronic control units, the low-voltage system electronic control unit controlling the low-voltage system equipment, and wherein the software update unit transmits first information inquiring presence or absence of information related to the update of the software to the server device, receives second information including update software from the server device, and determines, based on at least one of the electronic control units to be a target of the update software included in the second information, whether or not to make a transition to an activation process of the update software according to at least one of remaining electric power of the high-voltage battery and remaining electric power of the low-voltage battery.

According to the software update system of Configuration 1, the transition determination to the activation process is made in consideration of the remaining electric power of the battery of a type corresponding to the electronic control unit whose software is to be updated. Therefore, the transition determination to the activation process can be made appropriately.

### Configuration 2

The software update system according to Configuration 1, wherein the software update unit determines, in a case where the target of the update software included in the second information is only the high-voltage system electronic control unit, whether or not to make a transition to the activation process according to the remaining electric power of the low-voltage battery.

According to the software update system of Configuration 2, in a case where the target of the update software is only the high-voltage system control unit, the transition determination to the activation process is made in consideration of the remaining electric power of the low-voltage battery. Therefore, in the case where the software to be updated is software of the high-voltage system control unit, the transition determination to the activation process can be made appropriately.

### Configuration 3

The software update system according to Configuration 2, wherein the software update unit sets, in a case where the software update unit has determined to make a transition to the activation process, a time limit for the activation process to a first time duration.

According to the software update system of Configuration 3, the time limit for the activation process can be set to time corresponding to the case where the target of the software to be updated is only the high-voltage system control unit.

### Configuration 4

The software update system according to any one of Configurations 1 to 3, wherein the software update unit determines, in a case where the target of the update software included in the second information is only the low-voltage system electronic control unit, whether or not to make a transition to the activation process according to the remaining electric power of the high-voltage battery.

According to the software update system of Configuration 4, in the case where the target of the update software is only the low-voltage system control unit, the transition determination to the activation process is made in consideration of the remaining electric power of the high-voltage battery. Therefore, in the case where the software to be updated is software of the low-voltage system control unit, the transition determination to the activation process can be made appropriately.

### Configuration 5

The software update system according to Configuration 4, wherein the software update unit sets, in a case where the software update unit has determined to make a transition to the activation process, a time limit for the activation process to a second time duration.

According to the software update system of Configuration 5, the time limit for the activation process can be set to time corresponding to the case where the target of the software to be updated is only the low-voltage system control unit.

### Configuration 6

The software update system according to Configuration 5, wherein the second time duration is longer than the time limit of a case where the target of the update software included in the second information is only the high-voltage system electronic control unit.

In general, the high-voltage battery has a higher capacity than the low-voltage battery. Therefore, according to the software update system of Configuration 6, it is possible to perform the activation process on software with a large data capacity while preventing the remaining electric power of the battery from running out in the activation process.

### Configuration 7

The software update system according to any one of Configurations 1 to 6, wherein the software update unit determines, in a case where the target of the update software included in the second information is the high-voltage system electronic control unit and the low-voltage system electronic control unit, whether or not to make a transition to the activation process according to the remaining electric power of the high-voltage battery and the remaining electric power of the low-voltage battery.

According to the software update system of Configuration 7, in the case where the target of the update software is the high-voltage system control unit and the low-voltage system control unit, the transition determination to the activation process is made in consideration of the remaining electric power of the low-voltage battery and the high-voltage battery. Therefore, in the case where the software to be updated is software of the high-voltage system control unit and the low-voltage system control unit, the transition determination to the activation process can be made appropriately.

### Configuration 8

The software update system according to Configuration 7, wherein the software update unit causes, in a case where the software update unit has determined to make a transition to the activation process, the low-voltage system electronic control unit to first perform the activation process and the high-voltage system electronic control unit to subsequently perform the activation process.

According to the software update system of Configuration 8, since the activation process is performed by using the high-voltage battery first, the activation process can be performed by using the low-voltage battery that has been charged by the high-voltage battery. Therefore, even if the low-voltage battery has remaining electric power inapplicable to the activation process, the activation process can be performed by using the low-voltage battery.

### Configuration 9

A vehicle including electronic control units and capable of communicating with a server device, the vehicle including: a software update unit that performs update of software of the electronic control units; high-voltage system equipment; a high-voltage battery that supplies electric power to the high-voltage system equipment; a high-voltage system electronic control unit that is one of the electronic control units, the high-voltage system electronic control unit controlling the high-voltage system equipment; low-voltage system equipment; a low-voltage battery that supplies electric power to the low-voltage system equipment; and a low-voltage system electronic control unit that is another one of the electronic control units, the low-voltage system electronic control unit controlling the low-voltage system equipment, wherein the software update unit transmits first information inquiring presence or absence of information related to the update of the software to the server device, receives second information including update software from the server device, and determines, based on at least one of the electronic control units to be a target of the update software included in the second information, whether or not to make a transition to an activation process of the update software according to at least one of remaining electric power of the high-voltage battery and remaining electric power of the low-voltage battery.

According to the vehicle of Configuration 9, the same effect as the software update system of Configuration 1 is achieved.

### Configuration 10

A software update device provided in a vehicle including high-voltage system equipment, a high-voltage battery that supplies electric power to the high-voltage system equipment, low-voltage system equipment, and a low-voltage battery that supplies electric power to the low-voltage system equipment, the software update device performing update of software of electronic control units owned by the vehicle, the software update device including a software update unit that performs update of the software of a high-voltage system electronic control unit that is one of the electronic control units, the high-voltage system electronic control unit controlling the high-voltage system equipment, and a low-voltage system electronic control unit that is another one of the electronic control units, the low-voltage system electronic control unit controlling the low-voltage system equipment, wherein the software update unit transmits first information inquiring presence or absence of information related to the update of the software to a server device, receives second information including update software from the server device, and determines, based on at least one of the electronic control units to be a target of the update software included in the second information, whether or not to make a transition to an activation process of the update software according to at least one of remaining electric power of the high-voltage battery and remaining electric power of the low-voltage battery.

According to the software update device of Configuration 10, the same effect as the software update system of Configuration 1 is achieved.

### Configuration 11

A software update method for performing update of software of electronic control units owned by a vehicle capable of communicating with a server device, wherein the vehicle includes high-voltage system equipment, a high-voltage battery that supplies electric power to the high-voltage system equipment, a high-voltage system electronic control unit that is one of the electronic control units, the high-voltage system electronic control unit controlling the high-voltage system equipment, low-voltage system equipment, a low-voltage battery that supplies electric power to the low-voltage system equipment, and a low-voltage system electronic control unit that is another one of the electronic control units, the low-voltage system electronic control unit controlling the low-voltage system equipment, and wherein, in the update of the software, a processor provided in the vehicle transmits first information inquiring presence or absence of information related to the update of the software to the server device, receives second information including update software from the server device, and determines, based on at least one of the electronic control units to be a target of the update software included in the second information, whether or not to make a transition to an activation process of the update software according to at least one of remaining electric power of the high-voltage battery and remaining electric power of the low-voltage battery.

According to the software update method of Configuration 11, the same effect as the software update system of Configuration 1 is achieved.

### REFERENCE SIGNS LIST

1 software update system
2 vehicle
3 server device
4 base station
20 high-voltage battery
21 first control circuit
22 low-voltage battery
23 second control circuit
24 DC-DC converter
25 high-voltage system equipment
25A drive motor
26 low-voltage system equipment
26A wiper device
27 electronic control unit (ECU)
27A high-voltage system electronic control unit (high-voltage system ECU)
27B low-voltage system electronic control unit (low-voltage system ECU)
28 TCU
29 touch panel
30 server control unit
31 server communication unit
40 software update device
271 processor
272 memory
273 software
300 processor
310 memory
311 control program
400 processor
401 first remaining electric power acquisition unit
402 second remaining electric power acquisition unit
403 software update unit
410 memory
411 control program
D1 update software
MA storage area
NW communication network

1. A software update system comprising: a vehicle including electronic control units; and a server device capable of communicating with the vehicle,
wherein the vehicle includes
a software update unit that performs update of software of the electronic control units,
high-voltage system equipment,
a high-voltage battery that supplies electric power to the high-voltage system equipment,
a high-voltage system electronic control unit that is one of the electronic control units, the high-voltage system electronic control unit controlling the high-voltage system equipment,
low-voltage system equipment,
a low-voltage battery that supplies electric power to the low-voltage system equipment, and
a low-voltage system electronic control unit that is another one of the electronic control units, the low-voltage system electronic control unit controlling the low-voltage system equipment, and
wherein the software update unit
transmits first information inquiring presence or absence of information related to the update of the software to the server device,
receives second information including update software from the server device, and
determines, based on at least one of the electronic control units to be a target of the update software included in the second information, whether or not to make a transition to an activation process of the update software according to at least one of remaining electric power of the high-voltage battery and remaining electric power of the low-voltage battery.

2. The software update system according to claim 1, wherein
the software update unit determines,
in a case where the target of the update software included in the second information is only the high-voltage system electronic control unit,
whether or not to make a transition to the activation process according to the remaining electric power of the low-voltage battery.

3. The software update system according to claim 2, wherein
the software update unit sets,
in a case where the software update unit has determined to make a transition to the activation process,
a time limit for the activation process to a first time duration.

4. The software update system according to claim 1, wherein
the software update unit determines,
in a case where the target of the update software included in the second information is only the low-voltage system electronic control unit,
whether or not to make a transition to the activation process according to the remaining electric power of the high-voltage battery.

5. The software update system according to claim 4, wherein
the software update unit sets,
in a case where the software update unit has determined to make a transition to the activation process,
a time limit for the activation process to a second time duration.

6. The software update system according to claim 5, wherein
the second time duration is longer than the time limit of a case where the target of the update software included in the second information is only the high-voltage system electronic control unit.

7. The software update system according to claim 1, wherein
the software update unit determines,
in a case where the target of the update software included in the second information is the high-voltage system electronic control unit and the low-voltage system electronic control unit,
whether or not to make a transition to the activation process according to the remaining electric power of the high-voltage battery and the remaining electric power of the low-voltage battery.

8. The software update system according to claim 7, wherein
the software update unit causes,
in a case where the software update unit has determined to make a transition to the activation process,
the low-voltage system electronic control unit to first perform the activation process and the high-voltage system electronic control unit to subsequently perform the activation process.

9. A vehicle including electronic control units and capable of communicating with a server device, the vehicle comprising:
a software update unit that performs update of software of the electronic control units;
high-voltage system equipment;
a high-voltage battery that supplies electric power to the high-voltage system equipment;
a high-voltage system electronic control unit that is one of the electronic control units, the high-voltage system electronic control unit controlling the high-voltage system equipment;
low-voltage system equipment;
a low-voltage battery that supplies electric power to the low-voltage system equipment; and
a low-voltage system electronic control unit that is another one of the electronic control units, the low-voltage system electronic control unit controlling the low-voltage system equipment,
wherein the software update unit transmits first information inquiring presence or absence of information related to the update of the software to the server device,
receives second information including update software from the server device, and
determines, based on at least one of the electronic control units to be a target of the update software included in the second information, whether or not to make a transition to an activation process of the update software according to at least one of remaining electric power of the high-voltage battery and remaining electric power of the low-voltage battery.

10. A software update device provided in a vehicle including high-voltage system equipment, a high-voltage battery that supplies electric power to the high-voltage system equipment, low-voltage system equipment, and a low-voltage battery that supplies electric power to the low-voltage system equipment, the software update device performing update of software of electronic control units owned by the vehicle, the software update device comprising
a software update unit that performs update of the software of a high-voltage system electronic control unit that is one of the electronic control units, the high-voltage system electronic control unit controlling the high-voltage system equipment, and a low-voltage system electronic control unit that is another one of the electronic control units, the low-voltage system electronic control unit controlling the low-voltage system equipment,
wherein the software update unit
transmits first information inquiring presence or absence of information related to the update of the software to a server device,
receives second information including update software from the server device, and
determines, based on at least one of the electronic control units to be a target of the update software included in the second information, whether or not to make a transition to an activation process of the update software according to at least one of remaining electric power of the high-voltage battery and remaining electric power of the low-voltage battery.

11. A software update method for performing update of software of electronic control units owned by a vehicle capable of communicating with a server device,
wherein the vehicle includes high-voltage system equipment, a high-voltage battery that supplies electric power to the high-voltage system equipment, a high-voltage system electronic control unit that is one of the electronic control units, the high-voltage system electronic control unit controlling the high-voltage system equipment, low-voltage system equipment, a low-voltage battery that supplies electric power to the low-voltage system equipment, and a low-voltage system electronic control unit that is another one of the electronic control units, the low-voltage system electronic control unit controlling the low-voltage system equipment, and
wherein, in the update of the software,
a processor provided in the vehicle
transmits first information inquiring presence or absence of information related to the update of the software to the server device,
receives second information including update software from the server device, and
determines, based on at least one of the electronic control units to be a target of the update software included in the second information, whether or not to make a transition to an activation process of the update software according to at least one of remaining electric power of the high-voltage battery and remaining electric power of the low-voltage battery.
